(19) United States
(12) Patent Application Publication
(10) Pub. No.: US 2016/0169270 A1
(43) Pub. Date: Jun. 16, 2016

(54) CONNECTING ROD

(71) Applicant: Dr. Ing. h.c. F. Porsche Aktiengesellschaft, Stuttgart (DE)

(72) Inventors: Alfons Britten, Friedrichshafen (DE); Walter Buck, Ludwigsburg (DE); Frank Schaefer, Neulingen-Goebrichen (DE)

(21) Appl. No.: 14/961,925

(22) Filed: Dec. 8, 2015

(30) Foreign Application Priority Data
Dec. 11, 2014 (DE) 10 2014 118 404.1

(51) Int. Cl. F16C 7/02

(52) U.S. Cl. CPC F16C 7/023

(57) ABSTRACT

A connecting rod (1) has a small end (2) that is connectable rotatably to a piston, a connecting rod big end (3) that is connectable rotatably to a crankshaft, and a shank (4) between the ends (2, 3). The connecting rod big end (3) has a big end (5) and a connecting rod bearing cover (6) that can be screwed to the big end (5). Through bores (7) penetrate the cover (6) and threaded bores (8) penetrate the big end (5) in alignment with the through bores (7). Screws (9) penetrate the through bores (7) and screw into the threaded bores (8). A recess (10) is in the region of the respective threaded bore (8) on its side that faces away from the connecting rod bearing cover (6) and is directed toward the connecting rod big end (3) and is eccentric with respect to the thread axis (11).

### CROSS REFERENCE TO RELATED APPLICATION

This application claims priority under 35 USC 119 to German Patent Appl. No. 10 2014 118 404.1 filed on Dec. 11, 2014, the entire disclosure of which is incorporated herein by reference.

### BACKGROUND

1. Field of the Invention

The invention relates to a connecting rod having a connecting rod small end that can be connected rotatably to a piston and a connecting rod big end that is of split configuration and can be connected rotatably to a crankshaft. A connecting rod shank is between the connecting rod ends. The connecting rod big end has a big end on the connecting rod shank side and a connecting rod bearing cover that can be screwed to the big end. Through bores are arranged on both sides of the connecting rod big end in the connecting rod bearing cover. Threaded bores penetrate the big end and are flush with the through bores. Screws penetrate the through bores and are screwed into the threaded bores.

2. Description of the Related Art

Connecting rods are subjected to alternating high tension/compression loads during operation. These loads are superimposed by flexural stresses and torsional loading. Each of the various loads can vary considerably over the cross section and the length of a connecting rod. In particular, the region of the split connecting rod big end is subjected to high loads due to the screw connection. In addition, the loads change during use depending on the position of the connecting rod and therefore are variable over time. Therefore the connecting rod is subjected to a complex loading profile during use. A connecting rod for high performance applications must achieve criterion for high stability and a long service life, as well as an additional criterion of being able to manage high engine speeds.

EP 1 602 841 A2 discloses a connecting rod of the type mentioned above and has a screw connection at the big end and a connecting rod bearing cover. The screw connection takes place exclusively by screws and no nuts interact with the screws.

The threaded bore penetrates the big end completely in the known connecting rod, but the screw is screwed only partially into the threaded bore. Forces can be transmitted favorably between the big end and the screw. However, the threaded bore remains unused over a part length of the threaded bore in the region of the big end that faces away from the connecting rod bearing cover. A higher weight of the big end is a disadvantage due to the greater mass that must be moved.

Some connecting rods of the type described above have the screw screwed into the threaded bore at the big end over the entire length of the threaded bore. Here, the thread undercut at the end of the thread of the threaded bore is only a little larger than the internal diameter of the threaded bore. This leads to the operating load for the greatest part being absorbed by the last (upper) load-bearing thread turn. This results in very high stresses in the thread base directly above the last load-bearing thread turn.

It is an object of the invention to develop a connecting rod of the type mentioned above where the component stresses in the region of the last thread turn of the respective threaded bore are minimized and the service life of the connecting rod can be increased in a lasting manner.

### SUMMARY

The invention relates to a connecting rod where a side of the big end that faces away from the connecting rod bearing cover has a recess in the region of the respective threaded bore. The recess is directed in the direction of the connecting rod big end and is arranged eccentrically with respect to the thread axis.

This design reduces the loading of the last thread turn in the region of the big end of the connecting rod and distributes that part of the operating load to further thread turns. Thus, the component stresses also are reduced in that region, thereby increasing the forces that can be endured and extending the service life of the connecting rod.

The recess represents a defined radial step in the big end in the region of the respective threaded bore and suppresses the flow of force into the thread end and accordingly leads to massive relieving of the last thread turn.

In one embodiment, the contour of the recess runs parallel to the longitudinal axis of the threaded bore. This design simplifies forming the recess in the big end.

The recess may have a parabolic or partially circular contour on the side that is directed toward the connecting rod big end, in relation to a viewing direction in the axial extent of the threaded bore. This design contributes particularly to conducting the forces in the connecting rod in a manner that has reduced stress peaks.

The extent of the recess in the radial direction of the threaded bore, starting from the respective threaded bore, is preferably from 10% to 20%, preferably from 13% to 17%, in particular 15% of the diameter of the threaded bore.

Identical recesses may be arranged in the region of the threaded bores.

Further features of the invention result from the appended drawing and the description of the illustrated embodiments, without being restricted hereto.

### BRIEF DESCRIPTION OF THE DRAWINGS

FIG. 1 is a perspective view of a connecting rod according to the invention, as viewed obliquely from above in the direction of the connecting rod big end.

FIG. 2 is a perspective view of the detail marked with a circle in FIG. 1.

FIG. 3 is a cross-sectional view of the detail of FIG. 1 taken along the longitudinal axis of a screw that is screwed into the big end, and is sectioned perpendicular to the bearing axis of the two connecting rod eyes of the connecting rod.

FIG. 4 is a diagrammatic cross-sectional view of the lower region of the connecting rod shank and the connecting rod big end if the connecting rod of FIG. 1 taken perpendicular to the bearing axis of the connecting rod big end.

FIG. 5 shows the detail illustrated in FIG. 4.

FIG. 6 is cross sectional view similar to FIG. 4 but showing an example of the prior art.

FIG. 7 shows the detail of FIG. 6.

FIG. 8 graphically illustrates the stress conditions depending on the angular position in the thread turn both for the connecting rod of the invention and the prior art.

FIG. 9 is a diagram illustrating the stress conditions for the prior art in the external thread and in the internal thread depending on the respective thread turn.

FIG. 10 is a diagram illustrating the stress conditions for the invention in the external thread and in the internal thread depending on the respective thread turn.

FIG. 11 is a diagram illustrating the stress conditions relating to upper stress and lower stress depending on the respective thread turn for the prior art.

FIG. 12 is a diagram illustrating the stress conditions relating to upper stress and lower stress depending on the respective thread turn for the invention.

### DETAILED DESCRIPTION

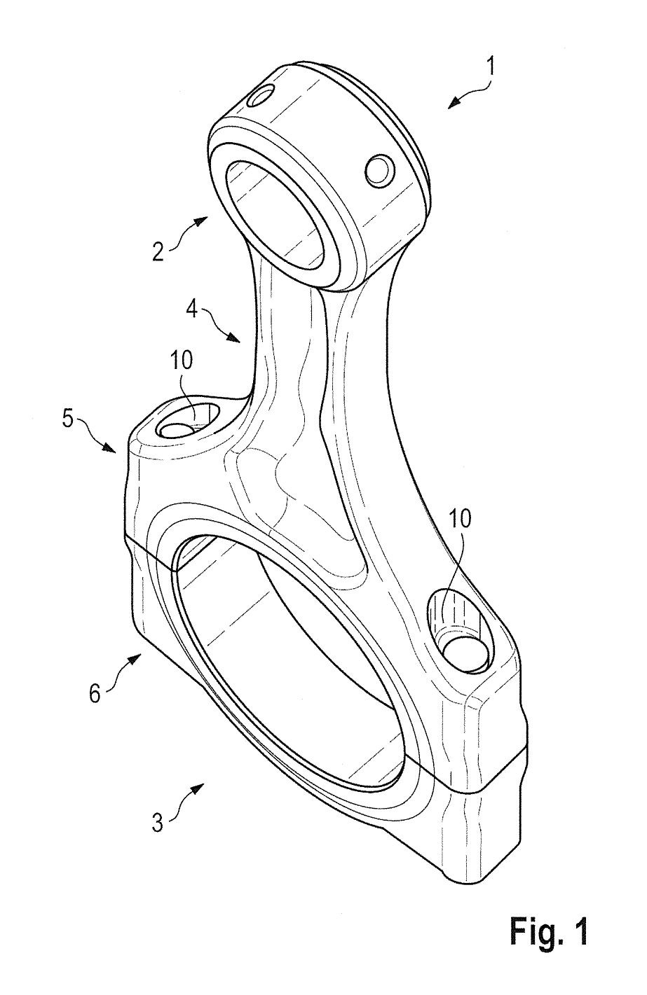

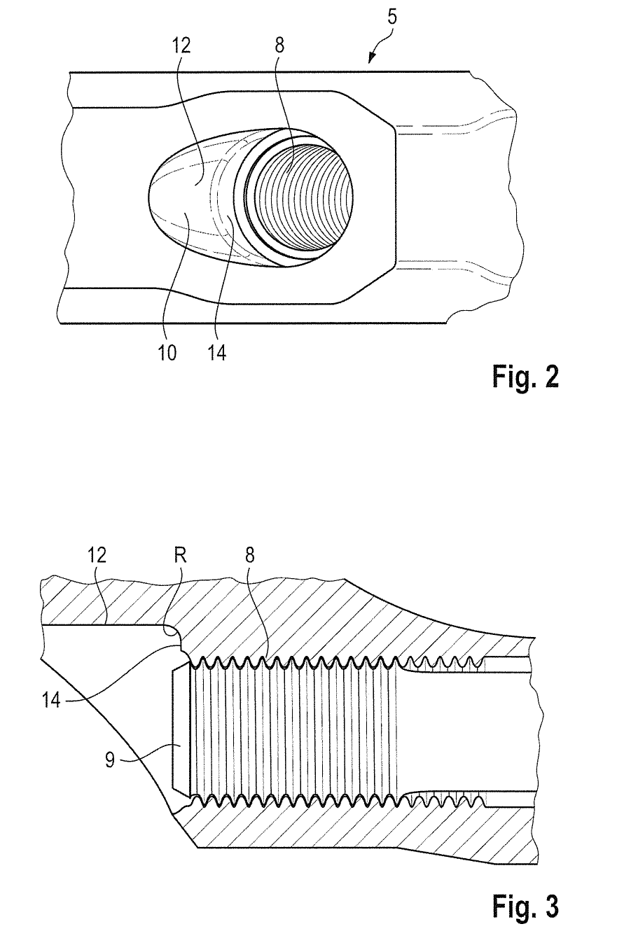

A connecting rod according to the invention is identified by the numeral 1 in FIGS. 1 to 5. The connecting rod 1 has a connecting rod small end 2 that can be connected rotatably to a piston and a connecting rod big end 3 that is of split configuration and can be connected rotatably to a crankshaft. A connecting rod shank 4 extends between the connecting rod ends 2, 3. The split configuration of the connecting rod big end 3 is achieved by a connecting rod bearing cover 6 that can be screwed to the big end 5. Two through bores 7 are arranged in the connecting rod bearing cover 6 on both sides of the connecting rod big end 3. Threaded bores 8 penetrate the big end 5 and register with the through bores 7 when the connecting rod 1 is assembled. Two screws 9 are provided. The respective screw 9 is plugged into the associated through bore 7 of the connecting rod bearing cover 6 and is screwed into the associated threaded bore 8 of the big end 5. The fastening of the connecting rod bearing cover 6 to the big end 5 therefore takes place exclusively by the two screws 9 and without nuts.

The side of the big end 5 that faces away from the connecting rod bearing cover 6 has a recess 10 in the region of the respective threaded bore 8. The recess 10 is directed in the direction of the connecting rod big end 3 and is positioned eccentrically with respect to the thread axis 11. Each threaded bore 8 is adjacent to the recess 10 and identical recesses 10 are arranged in the region of the threaded bores 8.

The contour 12 of the recess 10 runs parallel to the longitudinal axis of the associated threaded bore 8 and hence parallel to the thread axis 11. In relation to a viewing direction in the axial extent of the threaded bore 8, the recess 10 has a parabolic contour 12 on the side that is directed toward the connecting rod big end 3. A partially circular or semicircular contour can be provided instead of the parabolic contour in the region, and such a partially circular contour may be adjoined by two contour sections that run in parallel.

The extent of the recess 10 in the radial direction of the respective threaded bore 8, starting from the respective threaded bore 8, is from 10 to 20%, preferably from 13 to 17%, in particular 15% of the diameter of the threaded bore 8.

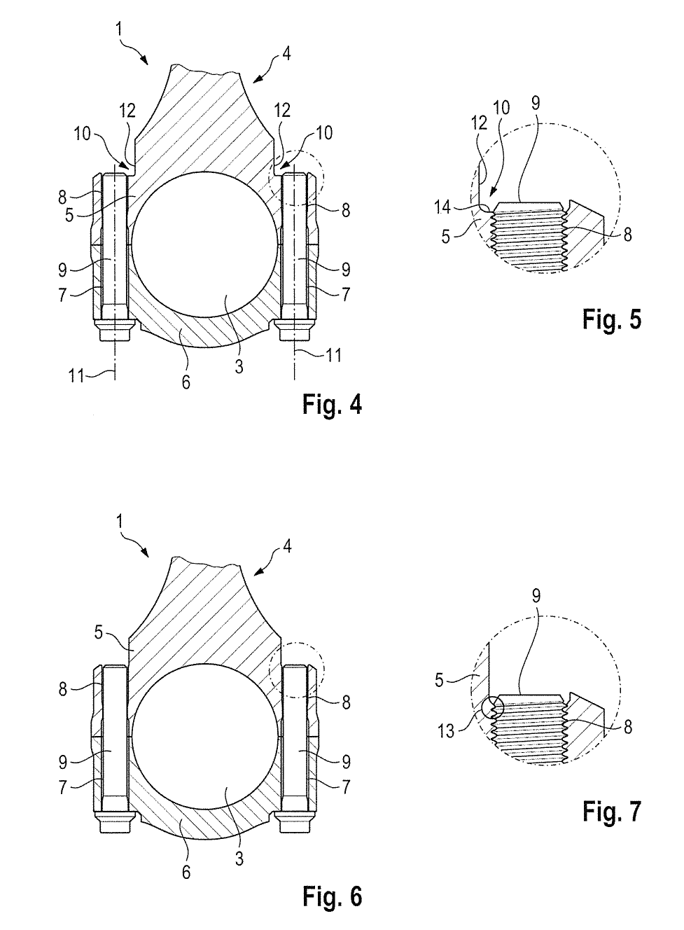

A comparison of the prior art illustrated in FIGS. 6 and 7 with the exemplary embodiment of the invention in FIGS. 4 and 5, that the thread-free bore at the end of the connecting rod thread is only a little larger in the prior art than the diameter of the internal thread of the big end. The operating load is therefore absorbed for the greatest part by the last (upper) load-bearing thread turn, as illustrated in FIG. 7 by the circle 13. This results in very high stresses in the thread base directly above the last load-bearing thread turn.

In the embodiment of the invention illustrated in FIG. 5, the recess 10 points in the direction of the connecting rod big end 3 and is eccentric with respect to the thread axis 11. This achieves a situation where the loading of the last thread turn, caused by the operating load, is reduced and is distributed to further thread turns. As a consequence, the component stresses also are reduced in this region. This increases the forces that can be endured and extends the service life of the connecting rod.

In the exemplary embodiment of FIGS. 1 to 3, the recess 10 is configured to extend inward by 2 mm starting from that side of the threaded bore 8 that faces the connecting rod big end 3. Here, a radius R of 1.0 mm with respect to the bottom 14 of the recess 10 is formed.

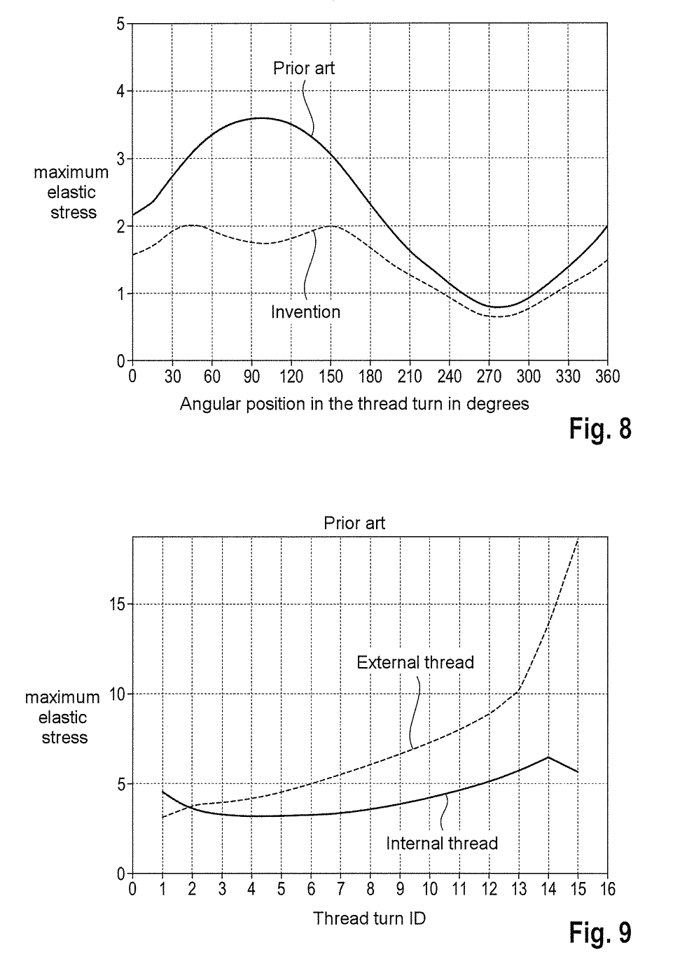

FIGS. 8 to 12 are diagrams that illustrate details in relation to the connecting rod according to the prior art or according to the invention, or directly compare details of said connecting rod:

FIG. 8 illustrates the maximum stresses determined in the test in the threaded bore 8, that is to say in the internal thread, the maximum stresses being evaluated in the circumferential direction of the threaded bore and being related in the example to the penultimate thread turn of the internal thread. For an angular position in the thread turn of 90° that corresponds to the connecting rod inner side, that is to say corresponds to the region that faces the connecting rod big end 3, the curve for the prior art shows that a maximum stress prevails there. For the curve of the embodiment of the connecting rod of the invention, a significant minimum results in contrast at said angular position of 90° in the thread turn, caused by the recess 10. The recess 10 reduces the stresses precisely where they are at their maximum. Otherwise, the undulating curves illustrate the pronounced flexural stress in the thread itself in the case of only tensile/compressive load on the connecting rod.

FIG. 9 illustrates the maximum stresses depending on the individual thread turns of the thread bore 8 of the prior art. Fifteen load-bearing thread turns are provided here. The stress profiles for the internal thread are illustrated, that is to say the threaded bore 8 of the titanium connecting rod and the external thread of the screw 9 composed of steel 10.9. It can be seen from the diagram that the introduction of force into the end of the internal thread, that is to say into the threaded bore 8 in the region of the first thread turn, brings about a damaging relative maximum stress.

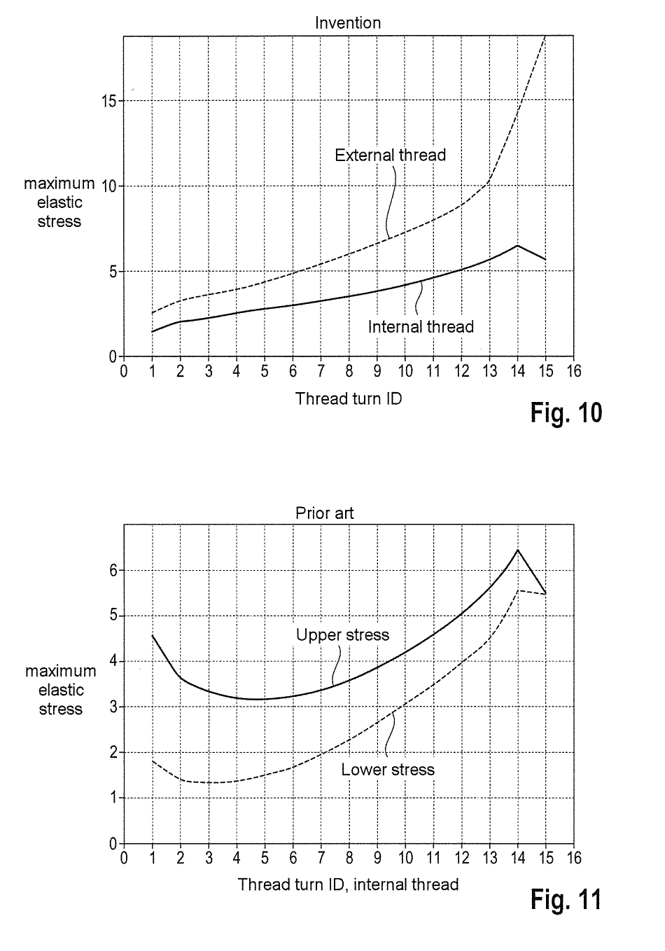

In contrast to FIG. 9, FIG. 10 shows that the relative maximum stress is reduced by the formation of the recess 10 in the region of the respective threaded bore 8 at the end of the internal thread, namely in the region of the first thread turn.

FIG. 11 illustrates the maximum stress for the prior art depending on the thread turn, once again for fifteen load-bearing thread turns, with primarily static loading by a screw prestressing force. The maximum stress amplitudes are illustrated in the thread turns, one curve showing the upper stress and the other curve showing the lower stress. Upper and lower stresses serve as a basis for the service life estimation of the connecting rod. FIG. 11 shows that particularly large damaging amplitudes are produced in the region of the first thread turn as a result of tension/compression on the connecting rod.

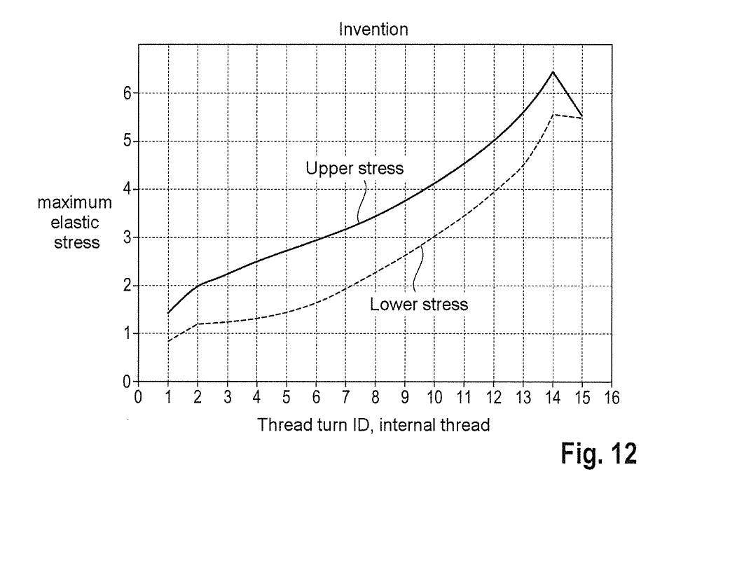

In contrast to FIG. 11, FIG. 12 shows the conditions in the design according to the invention. It can be gathered from FIG. 12 that the value of the upper stress and the value of the lower stress are substantially lower in the region of the first thread turn, and the amplitude between the upper stress and the lower stress is otherwise also lowered.

It can be determined for the discussed variant according to the prior art that, in said configuration of the connecting rod, the flow of force in the connecting rod is introduced in a targeted manner into the internal thread at end of the threaded bore, and high stresses and great amplitudes are generated in the thread turns there.

In the exemplary embodiment of the invention, in contrast, the undercutting of the thread end, and specifically the recesses 10 on the inner side of the connecting rod 1 using defined radial steps, makes it possible to suppress the flow of force into the thread end and to relieve the connecting rod massively there.

In comparison with the prior art, the invention allows the expectation of service life increases in the region of the threaded bore or the internal thread by a factor greater than 10. The location of maximum damage migrates away from the thread end toward the front thread turns, that is to say the classic failure location of screw connections.

### LIST OF DESIGNATIONS

1 Connecting rod
2 Connecting rod small end
3 Connecting rod big end
4 Connecting rod shank
5 Big end
6 Connecting rod bearing cover
7 Through bore
8 Threaded bore
9 Screw
10 Recess
11 Thread axis
12 Contour
13 Circle
14 Bottom

What is claimed is:

1. A connecting rod having a connecting rod small end that can be connected rotatably to a piston, a connecting rod big end that is of split configuration and can be connected rotatably to a crankshaft, and a connecting rod shank between the connecting rod ends, the connecting rod big end having a big end on the connecting rod shank side and a connecting rod bearing cover that can be screwed to the big end, and through bores being arranged on both sides of the connecting rod big end in the connecting rod bearing cover, and threaded bores penetrating the big end and being aligned with the through bores and, screws penetrating the through bores and being screwed into the threaded bores, a side of the big end that faces away from the connecting rod bearing cover having a recess in a region of the respective threaded bore, the recess being directed in a direction of the connecting rod big end and being eccentric with respect to a thread axis of the threaded bore.

2. The connecting rod of claim 1, wherein the respective threaded bore is adjacent to the recess, in relation to an axial extent of said threaded bore.

3. The connecting rod of claim 1, wherein an extent of the recess in the radial direction of the respective threaded bore, starting from the respective threaded bore, is from 10% to 20% of the diameter of the threaded bore.

4. The connecting rod of claim 1, wherein a contour of the recess runs parallel to the thread axis of the threaded bore.

5. The connecting rod of claim 1, wherein the recess has a parabolic contour or a partially circular contour on the side that is directed toward the connecting rod big end, in relation to a viewing direction in the axial extent of the threaded bore.

6. The connecting rod of claim 1, wherein identical recesses are arranged in the region of each of the threaded bores.
